(19) United States
(12) Patent Application Publication
(10) Pub. No.: US 2008/0210508 A1
(43) Pub. Date: Sep. 4, 2008

(54) Axle disconnect assembly with directional roller clutch

(76) Inventors: Zachary M. Heisey, Maumee, OH (US); Randy L. Sommer, Monroeville, IN (US)

Correspondence Address: BERENATO, WHITE & STAVISH, 6550 ROCK SPRING DRIVE, SUITE 240, BETHESDA, MD, 20817, US

(21) Appl. No.: 11/713,031

(22) Filed: Mar. 2, 2007

(51) Int. Cl. F16D 15/00; F16D 11/04; F16D 3/34

(52) U.S. Cl. 192/44; 180/274; 192/69.42; 384/445

(57) ABSTRACT

An axle disconnect assembly comprises a shaft extending axially along a central axis, a universal joint including an outer drive member having a substantially annular axial flange extending axially outwardly from the outer drive member coaxially with the central axis so as to form an annular space between the axial flange and the shaft, and a directional roller clutch disposed in the annular space. The directional roller clutch is provided for selectively drivingly coupling the shaft to the outer drive member of the universal joint. The directional roller clutch includes a plurality of rolling elements provided between the outer and inner race members. The rolling elements of the directional roller clutch radially support the outer drive member of the universal joint for rotation about to the shaft.

### BACKGROUND OF THE INVENTION

1. Field of the Invention

The present invention relates to axle disconnect assemblies in general and, more particularly, to an axle disconnect assembly including a directional roller clutch.

2. Description of the Prior Art

It is known to provide a part time all-wheel-drive vehicle that includes an axle disconnect mechanism in a front axle assembly. Such axle disconnect mechanisms include a vacuum motor and a shift fork assembly. The vacuum motor communicates with a vacuum source that is controlled by a two position solenoid valve. The fork shift assembly under control of the vacuum motor controls the axial shifting of a clutch collar between positions corresponding to coupled and uncoupled operating modes. This conventional system has the drawback of an externally mounted vacuum motor that requires considerable extra space particularly when vehicle suspension travel is taken into account. The use of an externally mounted vacuum motor also necessitates the use of a fork shift assembly which adds to the cost and complexity of the prior art arrangement exemplified by this system.

It is also known that a part time all-wheel-drive vehicle may include an axle disconnect in the front axle assembly, wherein the axle disconnect is operated by a power shift mechanism. The power shift mechanism includes sealed envelopes in the form of expandable and contractible compartments that shift the axle disconnect into and out of engagement in response to a remote control valve. The sealed envelopes are offset from the axle housing. The shiftable drive gear couples and uncouples inner and outer drive shafts. This power shift mechanism requires two sealed envelopes and numerous other parts operatively connecting the sealed envelopes with the shiftable drive gear. Moreover, such prior art axle disconnect systems do not provide a modular arrangement necessary for easy of manufacture, assembly and repair. Consequently these prior art arrangements are also complex and expensive to produce particularly when the difficulty of assembly is taken into account.

Thus, the axle disconnect assemblies of the prior art, including but not limited to those discussed above, are susceptible to improvements that may enhance their performance and cost. The need therefore exists for an axle disconnect assembly that is simple in design, compact in construction and economical to package and manufacture.

### SUMMARY OF THE INVENTION

The present invention provides a novel axle disconnect assembly such as for a part-time all-wheel-drive motor vehicle.

An axle disconnect assembly comprises a shaft extending axially along a central axis, a universal joint including an outer drive member and an inner drive member disposed substantially within said outer drive member, and a directional roller clutch provided for selectively drivingly coupling the shaft to the outer drive member of the universal joint. The outer drive member has a substantially annular axial flange extending axially outwardly from the outer drive member coaxially with the central axis so as to form an annular space between the axial flange and the shaft. The directional roller clutch is disposed in the annular space and includes a plurality of rolling elements provided between the outer and inner race members. The rolling elements of the directional roller clutch radially support the outer drive member of the universal joint for rotation about to the shaft.

Therefore, the present invention provides substantially improved packaging of the axle disconnect assembly providing compact, yet robust arrangement of the axle disconnect arrangement. The axle disconnect assembly of the present invention is simple in design, compact in construction and economical to package and manufacture. Thus, the present invention reduces cost, complexity and weight of the axle disconnect assembly.

### BRIEF DESCRIPTION OF THE DRAWINGS

FIG. 1 is a part-time all-wheel-drive power transmission system for a motor vehicle according to a preferred embodiment of the present invention;

FIG. 2 is a partial sectional view of an auxiliary drive axle assembly according to the preferred embodiment of the present invention;

FIG. 3 is a cross-sectional view of an axle disconnect assembly according to the preferred embodiment of the present invention;

FIG. 4 is a partial exploded cross-sectional view of an outer drive member of a universal joint and axle housing according to the preferred embodiment of the present invention.

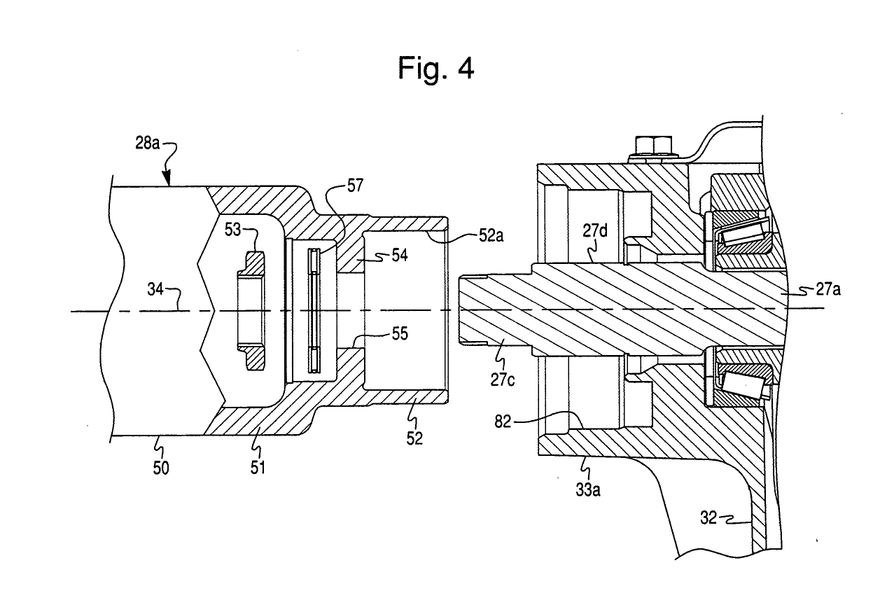

### DESCRIPTION OF THE PREFERRED EMBODIMENTS

The preferred embodiments of the present invention will now be described with the reference to accompanying drawing.

For purposes of the following description, certain terminology is used in the following description for convenience only and is not limiting. The words such as “front” and “rear”, “left” and “right”, “inboard” and “outboard”, “inwardly” and “outwardly” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

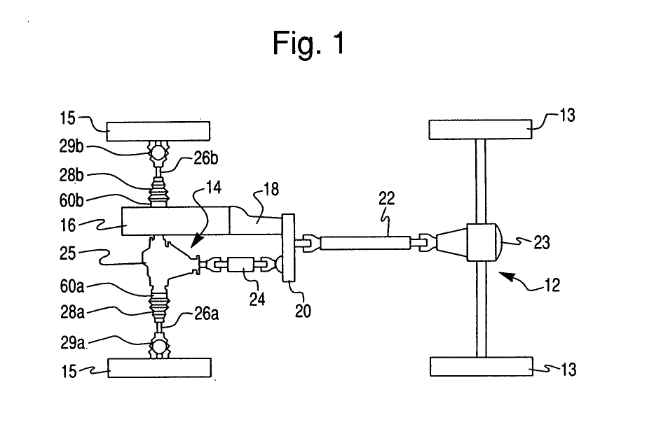

Referring to FIG. 1 of the drawings, a preferred embodiment of a part-time all-wheel-drive power transmission system of the present invention, generally denoted by reference numeral 10, for use in a conventional motor vehicle, is illustrated. The power transmission system 10 comprises a main (in this embodiment, rear) drive axle assembly 12 driving rear wheels 13 in a well known manner, a auxiliary (in this embodiment, front) drive axle assembly 14 driving front wheels 15, an engine 16 drivably connected to an automatic or manually operated transmission 18, and a transfer case 20 that distributes torque between the rear and front drive axle assemblies 12 and 14.

As used herein, the term “main” will refer to those drive wheels and associated components which are constantly connected to the engine 16 of the vehicle. The term “auxiliary” will refer to those drive wheels and associated components which are only selectively (part-time) connected to the engine 16 of the vehicle. Although the present invention will be described and illustrated as though the rear wheels of the vehicle constitute the primary drive wheels and the front wheels of the vehicle constitute the secondary drive wheels, it will be appreciated that the opposite situation (i.e., primary drive wheels in the front and secondary drive wheels in the rear) is contemplated to be within the scope of the present invention.

The transfer case typically includes an input shaft, a main output shaft and an auxiliary output shaft. The internal details of the transfer case 20 and details of a selector mechanism are not shown because these are conventional and well known components. The main output shaft of the transfer case 20 is drivingly connected to a main (rear) driveshaft 22 which, in turn, is drivingly connected to a main (rear) differential assembly 23 of the main (rear) drive axle assembly 12 that drives the rear wheels 13 in a well known manner. Similarly, the auxiliary output shaft is drivingly connected to an auxiliary (front) driveshaft 24 which, in turn, is drivingly connected to an auxiliary (front) differential assembly 25 of the auxiliary (front) drive axle assembly 12 for selectively driving the front wheels 15. Specifically, the front driveshaft 24 of the transfer case 20 is connected through the front differential assembly 25 to corresponding left and right drive shafts 26a and 26b, respectively, of the front drive axle assembly 14. As further illustrated in FIG. 1 the front differential assembly 25 is coupled to the left and right drive shafts 26a and 26b through inner universal joints, preferably in the form of constant velocity (CV) joints 28a and 28b, respectively. Furthermore, the front wheels 15 are coupled to the left and right drive shafts 26a and 26b through outer universal joints, preferably in the form of constant velocity (CV) joints 29a and 29b, respectively.

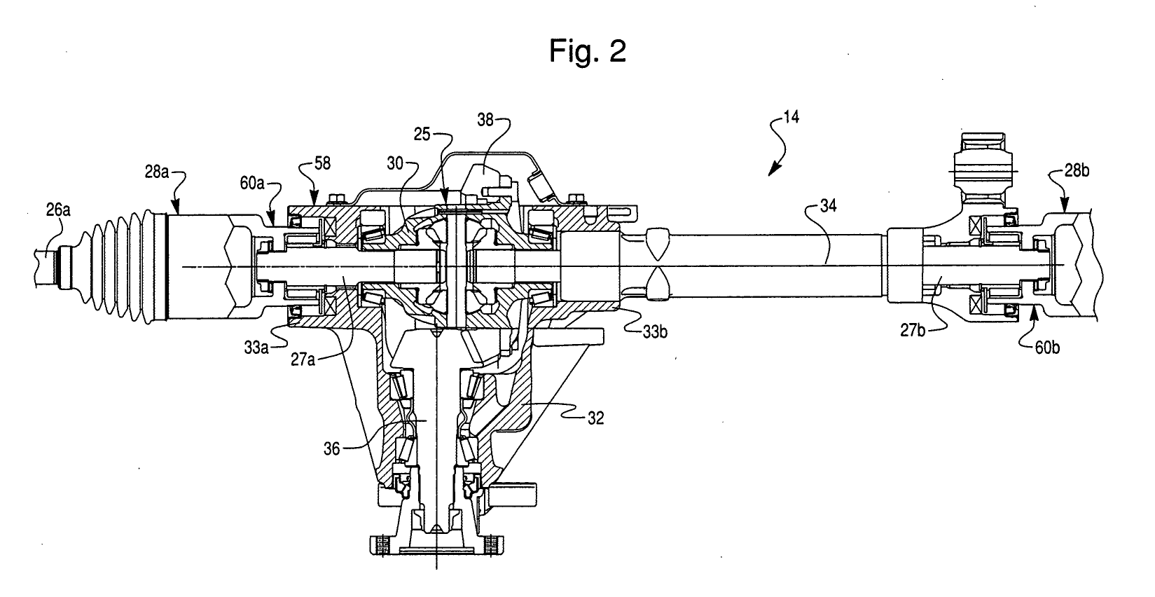

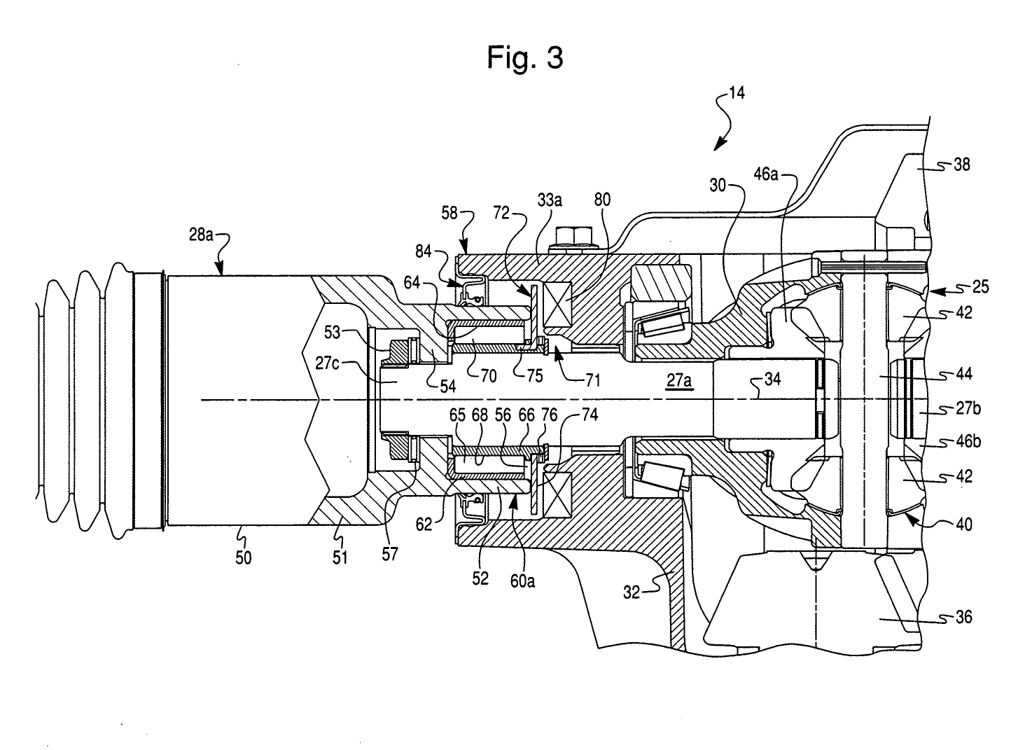

As illustrated in detail in FIG. 2, the auxiliary differential assembly 25 of the auxiliary drive axle assembly 14 includes a differential case 30 mounted in an axle housing 32 for rotation about a central axis of rotation 34. A bevel pinion gear 36 of the differential assembly 25 is drivingly connected to the front driveshaft 24 of the transfer case 20. In turn, the bevel pinion gear 36 in mesh with a ring gear 38 fixed to the differential case 30 of the differential assembly 25. The differential assembly 25 also includes a differential mechanism 40 disposed within the differential case 30. The internal details of the differential assembly 25 are not disclosed in detail because these are conventional and well known components. Specifically, as illustrated in FIGS. 2 and 3, the differential mechanism 40 includes a set of pinion gears 42 rotatably supported on a pinion shaft 44 secured to the differential case 30. The pillion gears 42 engage a pair of opposite side gears 46a, 46b adapted to rotate about the central axis 34.

The auxiliary drive axle assembly 14 further comprises left and right axle shafts 27a and 27b, respectively, extending axially outwardly from the differential case 30 through substantially cylindrical housing sleeves (lateral extensions) 33a and 33b of the axle housing 32 in opposite directions along the central axis 34 thereof. As shown in FIG. 2, the housing sleeves 33a and 33b outwardly extend in opposite directions from the axle housing 32 substantially coaxially with the central axis 34. The axle shafts 27a and 27b are rotatably supported within the axle housing 32 for rotation about the central axis 34. The axle shafts 27a and 27b are rotatably driven by the corresponding side gears 46a and 46b of the differential mechanism 40 that are non-rotatably coupled to the axle shaft 27a and 27b in any appropriate manner, such as by a spline connection.

The left and right CV joints 28a and 28b are substantially identical, both structurally and functionally, therefore only one of the CV joints is disclosed in details herein below. The left CV joint 28a, as illustrated in detail in FIG. 3, includes an outer drive member 50 and an inner drive member (not shown) disposed substantially within the outer drive member 50. The outer drive member 50 is selectively drivingly connectable to the axle shaft 27a, while the inner drive member of the CV joint 28a is drivingly connected to the corresponding drive shaft 26a. The outer drive member 50 includes a hollow, cup-shaped body 51 receiving the inner drive member therewithin, a substantially annular axial flange 52 extending axially outwardly from the cup-shaped body 51, and a substantially radially oriented end wall 54 of the outer drive member 50.

The annular axial flange 52 extends substantially coaxially with the central axis 34 into the lateral extension 33a of the axle housing 32 so as to form an annular space 56 between the axial flange 52 and the axle shaft 27a. In turn, the end wall 54 is provided with a central opening 55 therethrough so as to receive an outboard distal end 27c of the axle shaft 27a axially extending through the central opening 55. Moreover, the outer drive member 50 of the CV joint 28a is axially secured to the axle shaft 27a with a nut 53. Furthermore, as the outer drive member 50 is rotatably connected to the axle shaft 27a, a thrust bearing 57 is provided between the nut 53 and the end wall 54.

The auxiliary (front) drive axle assembly 14 further includes an axle disconnect assembly 58 including at least one directional clutch provided for selectively connecting/disconnecting the auxiliary drive axle assembly 14 of the all-wheel-drive power transmission system 10. Specifically, the at least one directional clutch of the present invention selectively disconnects at least one of the front (auxiliary) wheels 15 from the differential assembly 25, thus from the engine 16 of the motor vehicle. In other words, one or two directional clutches disconnect the front wheels 15 from the all-wheel-drive system 10. When the all-wheel-drive vehicle is traveling on dry pavements or highways, it is not necessary for the drive torque to be transmitted from the engine 16 to the front wheels 15. Even if the transfer case 20 is in a true two-wheel-drive position, and no drive torque is being transmitted to the auxiliary (front) drive axle assembly 14, the auxiliary drive axle assembly 14 and the drive shafts 26a, 26b are being driven by the wheels 15 causing parasitic losses. If the auxiliary drive axle assembly 14 can be stopped from rotating, this parasitic loss can be reduced.

According to the present invention, the axle disconnect assembly 58 of the secondary drive axle assembly 14 comprises one or two directional roller clutches (60a and 60b) provided to selectively disconnect the front wheels 15 from the rest of the front drive axle assembly 14 to reduce drag on the primarily rear wheel drive of the all-wheel-drive vehicle. More specifically, the directional roller clutch(es) (60a and 60b) selectively connecting/disconnecting the front axle shaft(s) (27a, 27b) from the CV joint(s) (28a, 28b) and the drive shaft(s) (26a, 26b). In other words, this axle disconnect assembly 58 can be used as a single disconnect by using only one directional clutch, or as a dual disconnect using two directional clutches.

According to the preferred embodiment of the present invention illustrated in FIG. 1, the secondary drive axle assembly 14 comprises first and second directional roller clutches 60a and 60b, respectively, provided for selectively drivingly coupling the corresponding axle shafts 27a or 27b to the outer drive members 50 of the respective CV joint 28a or 28b. Each of the directional roller clutches 60a and 60b is disposed in the annular space 56 defined between the outer flange 52 of the respective CV joint 28a or 28b and the corresponding axle shaft 27a or 27b. Preferably, each of the directional clutches 60a and 60b is in the form of a bi-directional roller clutch, i.e. the roller clutch capable of transferring torque in both directions: from the axle shaft to the wheel and from the wheel to the axle shaft.

Since directional roller clutches are well known in the art, the directional roller clutches 60a and 60b are not being described in greater detail herein. Moreover, the left (or first) and right (or second) directional clutches 60a and 60b are substantially identical, both structurally and functionally, therefore only one of the directional clutches 60a and 60b is disclosed in general terms herein below. The left directional roller clutch (first) of the exemplary embodiment of the present invention, as illustrated in detail in FIG. 3, includes an outer race member 62 rotatable about the central axis 34 and having a cylindrical outer raceway surface 64, an inner race member 66 also rotatable about the central axis 34 and having a cammed inner raceway surface 68 coaxial with the cylindrical outer raceway surface 64 of the outer race member 62, and a plurality of rolling elements, such as rollers 70, provided in a gap 65 between the inner raceway surface 64 of the outer race member 62 and the outer raceway surface 68 of the inner race member 66. The outer race member 62 is non-rotatably fixed to an inner peripheral surface 52a of the outer flange 52 of the outer drive member 50 by any appropriate manner known in the art, such as by interference fit, welding, etc., while the inner race member 66 is non-rotatably fixed to an outer peripheral surface 27d of the axle shaft 27a. Besides of selectively drivingly coupling the axle shaft 27a to the outer drive member 50 of the CV joint 28a, the rollers 70 of the directional roller clutch 60a radially rotatably supports the outer drive member 50 of the CV joint 28a for rotation about the axle shaft 28a.

The cammed inner raceway surface 68 of the inner race member 66 includes a plurality of cam surfaces (not shown) formed at equidistantly spaced apart locations which define a plurality of cam members on the inner raceway surface 68 of the inner race member 66. Each cam surface defines a wedge-shaped space in the gap 65 which is narrow on both sides thereof between itself and the cylindrical inner race member 66. It will be appreciated that alternatively the outer race member 62 may have a cammed outer raceway surface including a plurality of cam members, while the inner race member 66 has a cylindrical inner raceway surface coaxial with the cammed outer raceway surface of the outer race member 62. The rollers 70 are positioned between the outer race member 62 and the inner race member 66 with one roller 70 being located between two adjacent cam members of the inner raceway surface 68 of the inner race member 66. The rollers 70 have a diameter which is smaller than the gap between the outer raceway surface 64 and midpoints between two adjacent cam members of the inner raceway surface 68, but greater than the gap between the cam members of the inner raceway surface 68 and the outer raceway surface 64.

The rollers 70 are interconnected by a cage retainer (not shown) which causes the rollers 70 to circumferentially move in unison with one another. The cage retainer is rotatable about the central axis 34. Each of the rollers 70, as an engaging element, is mounted between two adjacent cam members of the outer raceway surface 68 of the inner race member 66 so that when the rollers 70 are moved a predetermined distance in either circumferential direction relative to the inner race member 66 by the cage retainer, they will engage between the cam surfaces of the outer raceway surface 68 of the inner race member 66 and the cylindrical outer raceway surface 68 of the inner race member 66, thus engaging the directional roller clutch 60a and interlocking the outer drive member 50 and the axle shaft 27a. A biasing element is provided for biasing the cage retainer to a neutral position where the rollers 70 do not engage the cam members on the outer raceway surface 68 of the inner race member 66. In other words, normally the cage retainer is biased by the biasing element into the neutral position wherein the rollers 70 are held at the midpoints between two adjacent cam surfaces so that the outer and inner race members 62 and 66 are freely rotatable relative to each other. Thus, in the neutral position of the rollers 70, the directional roller clutch 60a is in a disengaged position and the front axle shaft 27a is disconnected from the CV joint 28a and the drive shaft 26a.

The directional roller clutch 60a further includes an electromagnetic actuator 71 for selectively actuating (engaging) the directional roller clutch 60a. Preferably, the actuator 71 includes an electromagnet 80 non-rotatably mounted to the axle housing 32 in an annular recess 82 formed therein, and an annular armature 72 arranged so as to face the electromagnet 80. The armature 72 is supported on the inner race member 66 so as to be axially movable relative thereto towards and away from the electromagnet 80. Moreover, the armature 72 is biased by a compression spring element 76 away from the electromagnet 80 so that the armature 72 is always spaced from the electromagnet 80. The armature 72 includes an armature plate 74 radially outwardly extending from an axially extending actuator member 75. Preferably, the armature plate 74 is formed integrally with the actuator member 75.

The armature 72 is axially movable by the electromagnet 80 and the spring element 76 between deactivated and activated positions. Specifically, when the electromagnet 80 is de-energized, the armature 72 is biased away from the electromagnet 80 by the spring element 76 to its deactivated position wherein a space between the armature plate 74 and the electromagnet 80 is at its maximum. In its deactivated position, the actuator member 75 of the armature 72 engages the biasing element so as to keep the rollers 70 at their neutral position. In other words, when the armature 72 is in the deactivated position, the directional roller clutch 60a is disengaged.

On the other hand, when the electromagnet 80 is energized, the armature 72 is biased toward the electromagnet 80 to its activated position wherein the space between the armature plate 74 and the electromagnet 80 is at its minimum. In its activated position, the actuator member 75 of the armature 72 disengages from the biasing element so as to allow the rollers 70 to move out of their neutral position to engaging position in the wedge spaces between the outer and inner race members 62 and 66. In other words, when the armature 72 is in the activated position, the directional roller clutch 60a is engaged and couples the front axle shaft 27a to the drive shaft 26a together, so that the rotation of the front axle shaft 27a is transmitted to the drive shaft 26a, hence to the front wheel 15.

In a normal driving condition (when the all-wheel-drive vehicle is traveling on dry roads or highway) it is not necessary for torque to be transmitted to the front axle assembly 14 or the front wheels 15. Even if the transfer case 20 is in a true two-wheel-drive mode, and no torque is being transmitted to the front axle assembly 14, the differential assembly 25 of the front axle assembly 14 and the front driveshaft 24 are being driven by the wheels 15, thus causing parasitic losses. If the front axle assembly 14 can be stopped from rotating, this parasitic loss can be drastically reduced.

For this reason, if the vehicle is operated in the normal driving condition, the electromagnet 80 is not energized (de-energized or deactivated) so that the armature 72 is spaced from the electromagnet 80 by the compression spring element 76 to the deactivated position of the armature 72 in which the cage retainer and the rollers 70 are placed in the neutral position thereof. Thus, when the electromagnet 80 is de-energized, the directional roller clutch 60a is disengaged and the front axle shaft 27a is disconnected from the outer drive members 50 of the CV joint 28a, hence from the drive shaft 26a. In such a condition, the auxiliary front wheels 15 are disengaged from the engine 16, and vehicle operates in a two-wheel drive mode so that no torque is transmitted to the front wheels 15.

However, if the vehicle is operated on a slippery road and additional traction of the auxiliary front wheels 15 is required, the electromagnet 80 is energized. Consequently, the outer and inner race members 62 and 66 are rotate relative to each other. When a current flows through the electromagnet 80, the armature 72 moves axially toward the electromagnet 80 due to its magnetic force to the activated position thereof. Consequently, the directional roller clutch 60a is actuated by moving the rollers 70 from the neutral position on the cammed outer raceway surface 68 of the inner race member 66 to the engaging positions thereof in the wedge spaces between the outer and inner race members 62 and 66. Thus, the directional roller clutch 60a couples the front axle shaft 27a to the drive shaft 26a together, so that the rotation of the front axle shaft 27a is transmitted to the drive shaft 26a, hence to the front wheel 15.

Preferably, the electromagnet 80 is connected to an electronic control unit (ECU) (not shown). The ECU receives input signals from various sensors, such as front and rear wheel speed sensors, a mode selection switch, an ABS, etc., and controls the current level supplied to the electromagnet 80.

An annular seal member 84 provides sealing contact at a location between the lateral extension 33a of the axle housing 32 and the axial flange 52 of the outer drive member 50. The seal member 84 prevents dirt, dust, and debris particles from reaching the directional roller clutch 60a.

As noted above, the axle disconnect assembly 58 can be in the form of a single disconnect or a dual disconnect in the front axle assembly 14. In the form of a single disconnect, it would provide a single directional roller clutch, such as 60a, placed on only one side of the auxiliary axle 14 and would disconnect the one axle shaft from the wheel. The other side would still be connected to the wheel and the drive shaft, both side gears and pinion mates of the front differential assembly 25, and the axle shaft on the side with the clutch would still spin. However, the pinion gear 36, the ring gear 38, and the front driveshaft 24 would not spin. In the form of a dual disconnect in the front axle 14, there would be one clutch at each end of the housing sleeves 33a and 33b of the differential case 30. Each clutch would disconnect the wheel from the axle shaft. Neither of the axle shafts would turn, nor would any of the other components in the auxiliary axle assembly 14. The dual disconnect would reduce the parasitic losses more than the single disconnect.

Therefore, the present invention provides substantially improved packaging of the axle disconnect assembly providing compact, yet robust arrangement of the axle disconnect arrangement. The axle disconnect assembly of the present invention is simple in design, compact in construction and economical to package and manufacture. Thus, the present invention reduces cost, complexity and weight of the axle disconnect assembly.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. An axle disconnect assembly comprising:
a shaft extending axially along a central axis;
a universal joint including an outer drive member and an inner drive member disposed substantially within said outer drive member, said outer drive member having a substantially annular flange extending axially from said outer drive member coaxially with said central axis so as to form an annular space between said axial flange and said shaft; and
a directional roller clutch disposed in said annular space, said directional roller clutch provided for selectively drivingly coupling said shaft to said outer drive member of said universal joint;
said directional roller clutch including a plurality of rolling elements provided between said outer and inner race members;
said rolling elements of said directional roller clutch radially supporting said outer drive member of said universal joint for rotation about to said shaft.

2. The axle disconnect assembly as defined in claim 1, wherein said directional roller clutch further includes an outer race member having a circumferentially extending outer raceway surface located around said central axis and an inner race member having a circumferentially extending inner raceway surface located around said central axis;
wherein said outer race member is mounted to an inner peripheral surface of said axial flange of said outer drive member of said universal joint and said inner race member is mounted to an outer peripheral surface of said shaft.

3. The axle disconnect assembly as defined in claim 2, wherein one of said outer raceway surface and said inner raceway surface has a plurality of cam surfaces formed at equidistantly spaced apart locations which define a plurality of cam members; each of said cam surfaces defines a wedge-shaped space in a gap which is narrow on both sides thereof between said outer raceway surface and said inner raceway surface.

4. The axle disconnect assembly as defined in claim 1, further including a thrust bearing axially supporting said outer drive member of said universal joint for rotation relative to said shaft.

5. The axle disconnect assembly as defined in claim 4, wherein said thrust bearing is mounted to a distal end of said shaft within said outer drive member of said universal joint.

6. The axle disconnect assembly as defined in claim 1, wherein said outer drive member has a substantially radially oriented end wall provided with a central opening therethrough so as to receive said distal end of said shaft through said central opening.

7. The axle disconnect assembly as defined in claim 1, further comprising an electromagnetic actuator for selectively actuating said directional roller clutch; said actuator includes an electromagnet and an annular armature axially movable relative thereto.

8. The axle disconnect assembly as defined in claim 7, wherein said armature is axially movable by said electromagnet between deactivated position in which said directional roller clutch is disengaged so that said shaft is disconnected from said universal joint, and an activated position in which said directional roller clutch is engaged so that said shaft is drivingly connected to said universal joint.

9. The axle disconnect assembly as defined in claim 7, wherein said electromagnetic actuator further comprises a compression spring element biasing said armature away from said electromagnet.

10. The axle disconnect assembly as defined in claim 1, wherein said universal joint is a constant velocity joint.

11. An auxiliary drive axle assembly of an all-wheel-drive motor vehicle, said auxiliary drive axle assembly comprising:
a differential assembly;
a first shaft extending axially outwardly from said differential assembly along a central axis thereof;
a first universal joint including an outer drive member and an inner drive member disposed substantially within said outer drive member, said outer drive member having a substantially annular flange extending axially from said outer drive member coaxially with said central axis so as to form an annular space between said axial flange and said first shaft; and
an axle disconnect assembly including a first directional roller clutch disposed in said annular space, said first directional roller clutch provided for selectively drivingly coupling said first shaft to said outer drive member of said first universal joint;
said first directional roller clutch including a plurality of rolling elements provided between said axial flange and said first shaft;
said rolling elements of said first directional roller clutch radially supporting said outer drive member of said first universal joint for rotation about said first shaft.

12. The auxiliary drive axle assembly as defined in claim 11, wherein said first directional roller clutch further includes an outer race member having a circumferentially extending outer raceway surface located around said central axis and an inner race member having a circumferentially extending inner raceway surface located around said central axis;
wherein said outer race member is mounted to an inner peripheral surface of said axial flange of said outer drive member of said first universal joint and said inner race member is mounted to an outer peripheral surface of said first shaft.

13. The auxiliary drive axle assembly as defined in claim 12, wherein one of said outer raceway surface and said inner raceway surface has a plurality of cam surfaces formed at equidistantly spaced apart locations which define a plurality of cam members; each of said cam surfaces defines a wedge-shaped space in a gap which is narrow on both sides thereof between said outer raceway surface and said inner raceway surface.

14. The auxiliary drive axle assembly as defined in claim 11, further including a thrust bearing axially supporting said outer drive member of said first universal joint for rotation relative to said first shaft.

15. The auxiliary drive axle assembly as defined in claim 14, wherein said thrust bearing is mounted to a distal end of said first shaft within said outer drive member of said first universal joint.

16. The auxiliary drive axle assembly as defined in claim 11, wherein said outer drive member has a substantially radially oriented end wall provided with a central opening therethrough so as to receive said distal end of said shaft through said central opening.

17. The auxiliary drive axle assembly as defined in claim 11, wherein said first directional roller clutch further comprises an electromagnetic actuator for selectively actuating said first directional roller clutch; said electromagnetic actuator includes an electromagnet and an annular armature axially movable relative thereto.

18. The auxiliary drive axle assembly as defined in claim 17, wherein said armature is axially movable by said electromagnet between deactivated position in which said first directional roller clutch is disengaged so that said first shaft is disconnected from said first universal joint, and an activated position in which said first directional roller clutch is engaged so that said first shaft is drivingly connected to said first universal joint.

19. The auxiliary drive axle assembly as defined in claim 17, wherein said first electromagnetic actuator further comprises a compression spring element biasing said armature away from said electromagnet.

20. The auxiliary drive axle assembly as defined in claim 11, wherein said first universal joint is a constant velocity joint.

21. The auxiliary drive axle assembly as defined in claim 11, wherein said first directional roller clutch is a bi-directional clutch.

22. The auxiliary drive axle assembly as defined in claim 11, further comprising:
a second shaft extending axially outwardly from said differential assembly along said central axis thereof opposite to said first shaft; and
a second universal joint including an outer drive member and an inner drive member disposed substantially within said outer drive member, said outer drive member having a substantially annular axial flange extending axially outwardly from said outer drive member coaxially with said central axis so as to form an annular space between said axial flange and said second shaft;
said axle disconnect assembly further including a second directional roller clutch disposed in said annular space, said second directional roller clutch provided for selectively drivingly coupling said second shaft to said outer drive member of said second universal joint;
said second directional roller clutch including a plurality of rolling elements provided between said axial flange and said second shaft;
said rolling elements of said second directional roller clutch radially rotatably supporting said outer drive member of said second universal joint for rotation about said second shaft.

23. The auxiliary drive axle assembly as defined in claim 22, wherein said second directional roller clutch is substantially similar to said first directional roller clutch.
